(19) United States
(12) Patent Application Publication
(10) Pub. No.: US 2003/0004970 A1
(43) Pub. Date: Jan. 2, 2003

(54) Method for releasing update locks on rollback to savepoint

(76) Inventor: Julie Ann Watts, Morgan Hill, CA (US)

Correspondence Address: SAWYER LAW GROUP, P.O. Box 51418, Palo Alto, CA, 94303, US

(21) Appl. No.: 09/894,073

(22) Filed: Jun. 28, 2001

(51) Int. Cl. G06F 12/00

(52) U.S. Cl. 707/200

(57) ABSTRACT

A method for selectively releasing locks when rolling back to a savepoint includes: providing at least one savepoint in a transaction, where at least one lock is assigned to the at least one savepoint and at least one lock is assigned to the transaction; rolling back the transaction to the at least one savepoint; and releasing the at least one lock assigned to the at least one savepoint, where the at least one lock assigned to the transaction is maintained. Locks which are to persist until commit are assigned to the transaction. Locks which are to be released when rolled back to a savepoint are assigned to the savepoint. When a rollback to the savepoint occurs, locks assigned to the savepoint are released while locks assigned to the transaction are maintained. In this manner, selective release of locks is provided without incurring unduly burdensome overhead.

### FIELD OF THE INVENTION

The present invention relates to database systems, and more particularly to transactions performed on database systems.

### BACKGROUND OF THE INVENTION

In relational database management systems (RDBMS), a “transaction” refers to an exchange between a workstation and a program, two workstations, or two programs that accomplish a particular action or result. The transaction begins when the exchange begins and ends when commitment is made to the particular action or result. Several conventional RDBMS support sub-transactions through the use of savepoints. Savepoints are created between the beginning of the transaction and the commit. The savepoints allow modifications made to data since a savepoint to be undone. This is referred to herein as “rollback to a savepoint”.

For example, assume that a user, through a workstation and/or application, accesses a RDBMS for a travel agency. The user wishes to book airline, hotel, and rental car reservations. The user researches available flights and books airline reservations. A first savepoint is established. The user further researches available hotels and books hotel reservations. A second savepoint is established. The user then researches available rental cars but cannot find a suitable reservation which matches the hotel reservation. The user may then roll back to the first savepoint to search for a different hotel. The data modified the first savepoint are undone so that the user can book reservations at a different hotel.

For transactions to occur with integrity, two transactions must be prevented from updating the same piece of data at the same time. Locks on the data being updated are typically used. For example, if user A, performing transaction A, is updating data pertaining to reservations for an airline flight, a lock is established on the airline flight data. With this lock, user B, performing transaction B, is prevented from updating the same airline flight data at the same time as user A, and must wait until transaction A completes and releases the lock.

Similarly, for transactions to read data with integrity, a read transaction must be prevented from seeing data that has been changed by an updating transaction but not yet committed, and be allowed to see data that has been changed by an updating transaction as soon as it is committed. Locks on the data being read are typically used. For example, if user A, performing transaction A, is updating data pertaining to reservations for an airline flight, a lock is established on the airline flight data. User B, performing read transaction B, cannot read that data until transaction A completes and releases the lock.

If a read transaction requires read stability or read repeatability for the duration of the transaction, read locks are held until the read transaction is completed. Thus, if transaction C is a read transaction that reads airline reservation information and that requires read stability or repeatability, transaction C will establish locks on all data read. Another transaction, D, wishing to update the airline reservation information, must wait for read transaction C to complete and release the lock.

When rollback to savepoint occurs, one must consider locks acquired since the savepoint. Those locks taken to provide read stability or repeatability of data read since the savepoint must not be released, while those locks taken to keep the changes, now being rolled back, from being seen by other transactions may be released.

Accordingly, there exists a need for a method for selectively releasing locks when rolling back to a savepoint. The method should not incur unduly burdensome overhead. The present invention addresses such a need.

### SUMMARY OF THE INVENTION

A method for selectively releasing locks when rolling back to a savepoint includes: providing at least one savepoint in a transaction, where at least one lock is assigned to the at least one savepoint and at least one lock is assigned to the transaction; rolling back the transaction to the at least one savepoint; and releasing the at least one lock assigned to the at least one savepoint, where the at least one lock assigned to the transaction is maintained. Locks which are to persist until commit are assigned to the transaction. Locks which are to be released when rolled back to a savepoint are assigned to the savepoint. When a rollback to the savepoint occurs, locks assigned to the savepoint are released while locks assigned to the transaction are maintained. In this manner, selective release of locks is provided without incurring unduly burdensome overhead.

### BRIEF DESCRIPTION OF THE FIGURES

FIG. 1 is a flowchart illustrating a preferred embodiment of a method for selectively releasing locks when rolling back to a savepoint in accordance with the present invention.

FIG. 2 is a flowchart illustrating a preferred embodiment of the method for selectively releasing locks when rolling back through a sequence of savepoints in accordance with the present invention.

FIG. 3 illustrates a preferred embodiment of a system which utilizes the method for selectively releasing locks when rolling back to a savepoint in accordance with the present invention.

### DETAILED DESCRIPTION

The present invention provides a method for selectively releasing locks when rolling back to a savepoint. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

The method in accordance with the present invention utilizes the concept of savepoint-transaction teams. Locks which are to persist until commit are assigned to the transaction. Locks which are released when rolled back to a savepoint are assigned to the savepoint. When a roll back to the savepoint occurs, the locks assigned to the savepoint are released while the locks assigned to the transaction are maintained.

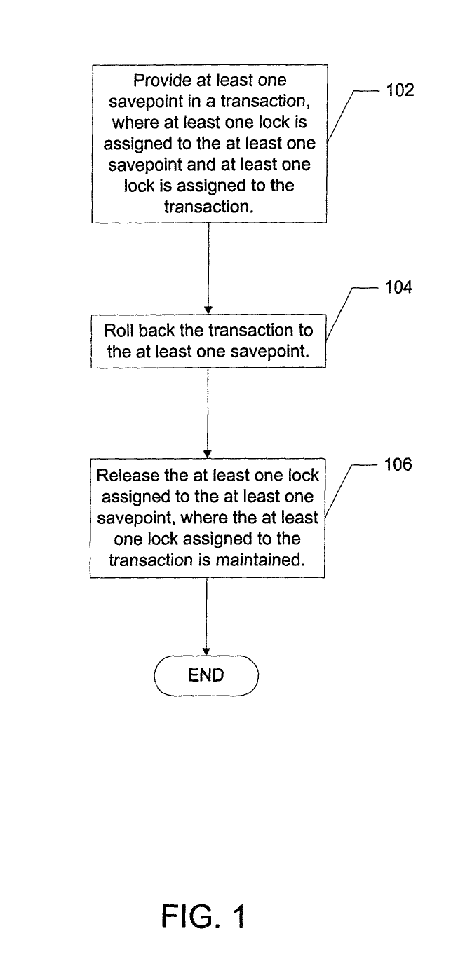

To more particularly describe the features of the present invention, please refer to FIGS. 1 through 3 in conjunction with the discussion below.

FIG. 1 is a flowchart illustrating a preferred embodiment of a method for selectively releasing locks when rolling back to a savepoint in accordance with the present invention. First, at least one savepoint in a transaction is provided, via step 102, where the at least one lock is assigned to the at least one savepoint and at least one lock is assigned to the transaction. In the preferred embodiment, locks which are to persist until commit are assigned to the transaction, and locks which are to be released when rolled back to the at least one savepoint is assigned to the at least one savepoint. When the transaction is rolled back to the at least one savepoint, via step 104, the at least one lock assigned to the at least one savepoint is released, via step 106, while the at least one lock assigned to the transaction is maintained.

For example, using the RDBMS for a travel agency example above, assume that the user wishes to book airline, hotel, and rental car reservations. The user researches available flights and books airline reservations. Locks acquired are assigned to the transaction. When the user is done with the airline reservations, a savepoint is established. The savepoint and the transaction becomes a team. The user then researches available hotels. Data which are to be updated in booking the hotel reservations are locked with “update locks”. Data which are read by the user in booking the hotel reservations are also locked with “read locks”. The update locks are assigned to the savepoint, and the read locks are assigned to the transaction, via step 102. Assume further that the user researches available hotels for a companion but cannot find a suitable reservation. The user then rolls back to the savepoint to change the hotel reservation, via step 104. In rolling back to the savepoint, the update locks assigned to the savepoint are released, while the read locks assigned to the transaction are maintained, via step 106.

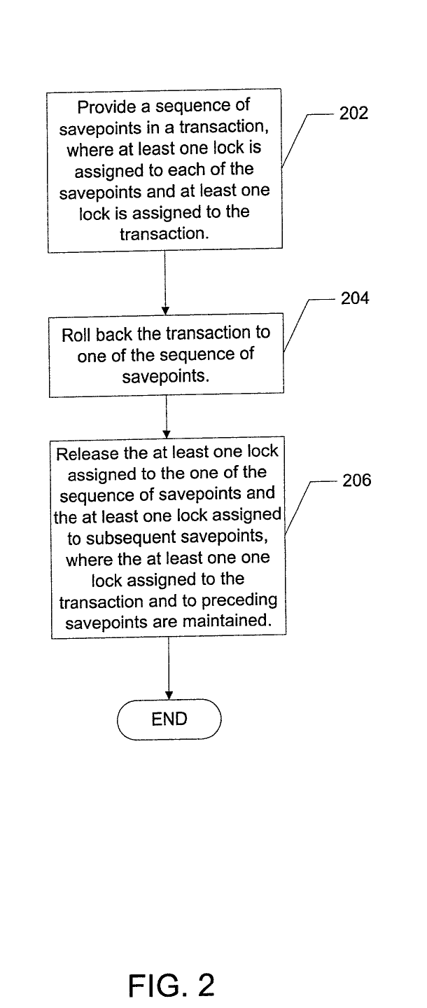

In addition to rolling back to the most recent savepoint, as illustrated in FIG. 1, the method in accordance with the present invention may also be used with a sequence of savepoints, where the transaction is rolled back through more than one savepoint. In this scenario, as each savepoint in the sequence is established, it joins the savepoint-transaction team. FIG. 2 is a flowchart illustrating a preferred embodiment of the method for selectively releasing locks when rolling back through a sequence of savepoints in accordance with the present invention. First, a sequence of savepoints in a transaction is provided, via step 202, where at least one lock is assigned to each of the savepoints and at least one lock is assigned to the transaction. When the transaction is rolled back to one of the sequence of savepoints, via step 204, the at least one lock assigned to the one of the sequence of savepoints is released, and the at least one lock assigned to each subsequent savepoint is also released, via step 206. The at least one lock assigned to the transaction and at least one lock assigned to preceding savepoints are maintained.

For example, using the RDBMS for a travel agency example above, the user wishes to book airline, hotel, and rental car reservations. The user books the airline reservations, and the locks acquired are assigned to the transaction. When the user is done with the airline reservations, a first savepoint is established. The first savepoint and the transaction become a team. The user researches available hotels and books hotel reservations. A first set of update locks acquired after the first savepoint is assigned to the first savepoint. A first set of read locks acquired after the first savepoint is assigned to the transaction. When the user is done with the hotel reservations, a second savepoint is established. The second savepoint is added to the team. The user then researches available rental cars. A second set of update locks acquired after the second savepoint is assigned to the second savepoint. A second set of read locks acquired after the second savepoint is assigned to the transaction. The first and second savepoints create a sequence of savepoints, via step 202. If the user later discovers that he/she cannot find a suitable rental car which matches the hotel reservation, then the user rolls back to the first savepoint to search for a different hotel, via step 204. In rolling back to the first savepoint, the first set of update locks assigned to the first savepoint is released, via step 206. The second savepoint is a subsequent savepoint. Thus, in rolling back to the first savepoint, the second set of update locks assigned to the second savepoint is also released. The first and second sets of read locks assigned to the transaction are maintained. In this example, there are no savepoints preceding the first savepoint. However, it there was, then the set of locks assigned to the preceding savepoint is maintained as well, via step 206.

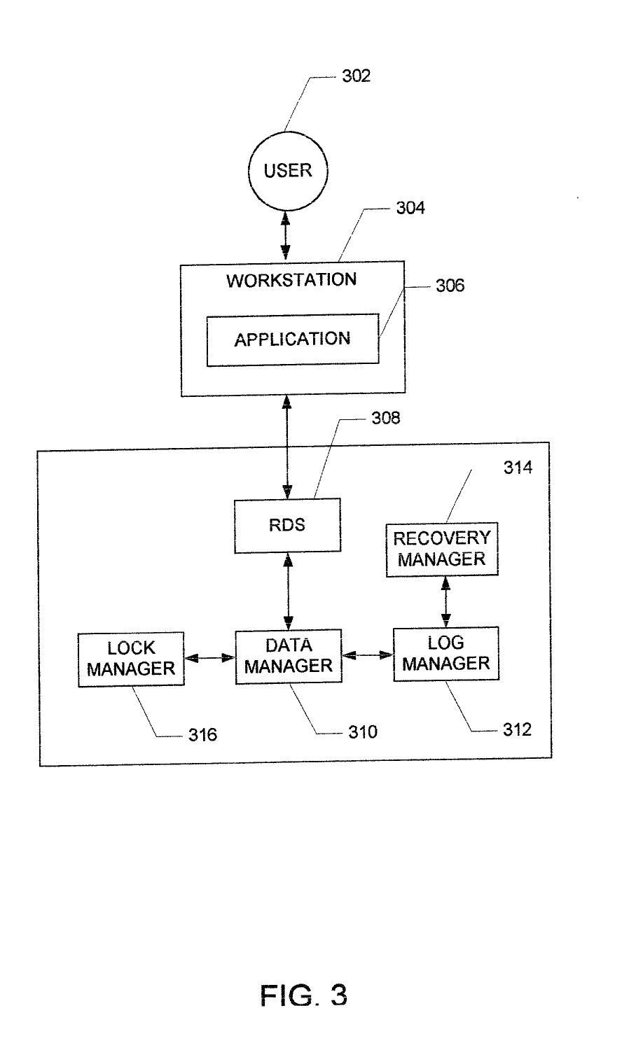

FIG. 3 illustrates a preferred embodiment of a system which utilizes the method for selectively releasing locks when rolling back to a savepoint in accordance with the present invention. The system comprises a relational data system 308 (RDS) and a data manager 310. The data manager 310 performs the tasks requested by a user 302, a workstation 304, or an application 306. The RDS 308 functions as an interface between the user 302, workstation 304, or application 306 and the data manager 310. The system also comprises a log manager 312, a recovery manager 314, and a lock manager 316. The log manager 312 maintains a log of tasks performed in the system. The recovery manager 314 manages rollbacks to savepoints and other tasks, such as transaction commit and system restart. The lock manager 316 manages data locks. In the preferred embodiment, the method in accordance with the present invention is implemented as software at the data manager 310 and the recovery manager 314. However, it may be implemented in other ways without departing from the spirit and scope of the present invention.

In the preferred embodiment, as the user 302, workstation 304, or application 306, through the RDS 308, progresses in a transaction, the data manager 310 requests locks from the lock manager 316 where appropriate. The lock manager 316 then creates and maintains the locks. The present invention relies on the capacity of the lock manager 316 to grant otherwise incompatible locks to both the transaction and the savepoint(s) by virtue of the fact that the transaction and the savepoint(s) are a team. When a savepoint is established, the data manager 310 assigns subsequent locks to either the savepoint or the transaction. All savepoints and data modifications are logged to the recovery log by the data manager 310 using the services of the log manager 312. When a rollback to savepoint occurs, the recovery manager 314 receives the request and advises the data manager 310 to perform the rollback. The data manager 310 then applies undo log records previously written to the recovery log by the log manager 312 until the savepoint log record is encountered. The data manager 310 requests the lock manager 316 to release locks assigned to the savepoint and subsequent savepoints. The locks assigned to the transaction and preceding savepoints continue to be maintained by the lock manager 316 until commit.

Although the present invention is described in the context of the system illustrated in FIG. 3, one of ordinary skill in the art will understand that the method can be utilized by other systems without departing from the spirit and scope of the present invention.

In the preferred embodiment, a savepoint may be subsequently released, for example, when it becomes clear the user will not rollback to the savepoint. When the savepoint is released, the method in accordance with the present invention may handle the locks assigned to the savepoint in one of two ways. The locks may be reassigned to the savepoint immediately preceding the released savepoint, or the knowledge of the released savepoints are maintained for purposes of releasing the locks if rollback to the preceding savepoint should occur. Other ways are possible without departing from the spirit and scope of the present invention.

A method for selectively releasing locks when rolling back to a savepoint has been disclosed. The method utilizes the concept of savepoint-transaction teams. Locks which are to persist until commit are assigned to the transaction. Locks which are to be released when rolled back to a savepoint are assigned to the savepoint. When a roll back to the savepoint occurs, the locks assigned to the savepoint are released while the locks assigned to the transaction are maintained. In this manner, selective release of locks is provided without incurring unduly burdensome overhead.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for selectively releasing locks on data, comprising the steps of:
(a) providing at least one savepoint in a transaction, wherein at least one lock is assigned to the at least one savepoint and at least one lock is assigned to the transaction;
(b) rolling back the transaction to the at least one savepoint; and
(c) releasing the at least one lock assigned to the at least one savepoint, wherein the at least one lock assigned to the transaction is maintained.

2. The method of claim 1, wherein the providing step (a) comprises:
(a1) providing a sequence of savepoints in the transaction, wherein at least one lock is assigned to each of the savepoints and the at least one lock is assigned to the transaction.

3. The method of claim 1, wherein the rolling step (b) comprises:
(b1) rolling back the transaction to one of a sequence of savepoints.

4. The method of claim 1, wherein the releasing step (c) comprises:
(c1) releasing at least one lock assigned to one of a sequence of savepoints to which the transaction is rolled back; and
(c2) releasing at least one lock assigned to subsequent savepoints, wherein the at least one lock assigned to the transaction and at least one lock assigned to preceding savepoints are maintained.

5. The method of claim 4, further comprising:
(c3) releasing another of the sequence of savepoints.

6. The method of claim 5, further comprising:
(c4) reassigning at least one lock assigned to the another of the sequence of savepoints to a preceding savepoint.

7. The method of claim 5, further comprising:
(c4) maintaining knowledge of the released another of the sequence of savepoints, such that if the transaction is rolled back to a preceding savepoint, the at least one lock assigned to the released another of the sequence of savepoints is released.

8. A method for selectively releasing locks on data, comprising the steps of:
(a) providing a sequence of savepoints in a transaction, wherein at least one lock is assigned to each of the savepoints and at least one lock is assigned to the transaction;
(b) rolling back the transaction to one of the sequence of savepoints;
(c) releasing the at least one lock assigned to the one of the sequence of savepoints; and
(d) releasing the at least one lock assigned to subsequent savepoints, wherein the at least one lock assigned to the transaction and the at least one lock assigned to preceding savepoints are maintained.

9. A computer readable medium with program instructions for selectively releasing locks on data, comprising the instructions for:
(a) providing at least one savepoint in a transaction, wherein at least one lock is assigned to the at least one savepoint and at least one lock is assigned to the transaction;
(b) rolling back the transaction to the at least one savepoint; and
(c) releasing the at least one lock assigned to the at least one savepoint, wherein the at least one lock assigned to the transaction is maintained.

10. The medium of claim 9, wherein the providing instruction (a) comprises instructions for:
(a1) providing a sequence of savepoints in the transaction, wherein at least one lock is assigned to each of the savepoints and the at least one lock is assigned to the transaction.

11. The medium of claim 9, wherein the rolling instruction (b) comprises instructions for:
(b1) rolling back the transaction to one of a sequence of savepoints.

12. The medium of claim 9, wherein the releasing instruction (c) comprises instructions for:
(c1) releasing at least one lock assigned to one of a sequence of savepoints to which the transaction is rolled back; and
(c2) releasing at least one lock assigned to subsequent savepoints, wherein the at least one lock assigned to the transaction and at least one lock assigned to preceding savepoints are maintained.

13. The medium of claim 12, further comprising instructions for:
(c3) releasing another of the sequence of savepoints.

14. The medium of claim 13, further comprising instructions for:
(c4) reassigning at least one lock assigned to the another of the sequence of savepoints to a preceding savepoint.

15. The medium of claim 13, further comprising instructions for:
(c4) maintaining knowledge of the released another of the sequence of savepoints, such that if the transaction is rolled back to a preceding savepoint, the at least one lock assigned to the released another of the sequence of savepoints is released.

16. A computer readable medium with program instructions for selectively releasing locks on data, comprising the instructions for:
(a) providing a sequence of savepoints in a transaction, wherein at least one lock is assigned to each of the savepoints and at least one lock is assigned to the transaction;
(b) rolling back the transaction to one of the sequence of savepoints;
(c) releasing the at least one lock assigned to the one of the sequence of savepoints; and
(d) releasing the at least one lock assigned to subsequent savepoints, wherein the at least one lock assigned to the transaction and the at least one lock assigned to preceding savepoints are maintained.

17. A system, comprising:
a transaction, wherein at least one lock is assigned to the transaction; and
at least one savepoint associated with the transaction, wherein at least one lock is assigned to the at least one savepoint, wherein in a rollback to the at least one savepoint, the at least one lock assigned to the at least one savepoint is released, wherein the at least one lock assigned to the transaction is maintained.

18. A system, comprising:
a data manager for performing tasks on data, wherein the tasks comprise:
providing at least one savepoint in a transaction,
assigning at least one lock to the at least one savepoint,
assigning at least one lock to the transaction,
responding to a recovery manager request for a rollback to the at least one savepoint by undoing operations performed since the at least one savepoint according to a log, and
requesting to a lock manager for release of the at least one lock assigned to the at least one savepoint;
the lock manager for creating and maintaining the at least one lock assigned to the at least one savepoint and the at least one lock assigned to the transaction, and for releasing the at least one lock assigned to the at least one savepoint when the transaction is rolled back to the at least one savepoint;
a log manager for storing information on the tasks in the log, wherein the log comprises information concerning data and schema modifications, and the at least one savepoint; and
the recovery manager, wherein the recovery manager processes the request for the rollback to the at least one savepoint by advising the data manager of the request.
